(19) United States
(12) Patent Application Publication
(10) Pub. No.: US 2011/0135238 A1
(43) Pub. Date: Jun. 9, 2011

(54) PLASTIC CAGE AND METHOD FOR PRODUCTING A CAGE

(75) Inventors: Arbogast Grunau, Weisendorf (DE); Stefan Kurzbeck, Erlangen (DE)

(73) Assignee: SCHAEFFLER TECHNOLOGIES GMBH & CO. KG, Herzogenaurach (DE)

(21) Appl. No.: 13/059,674

(22) PCT Filed: Aug. 18, 2009
(86) PCT No.: PCT/DE2009/001176

§ 371 Date: Feb. 18, 2011

(30) Foreign Application Priority Data
Aug. 20, 2008 (DE) 10 2008 038 577.8

(51) Int. Cl. B29C 35/08; F16C 33/44; F16C 33/56

(52) U.S. Cl. 384/576; 264/494; 264/488

(57) ABSTRACT

A method for producing a cage of a rolling bearing, for receiving a rolling body. The body of the cage is a plastic material that can be cross-linked by radiation, and is provided with rolling bodies later during the method. The body of the cage is fitted with the rolling bodies only once the structure of the cage has been exposed to the radiation. Also, a cage is disclosed for receiving rolling bodies of a rolling bearing, which has a body consisting of a plastic material.

### FIELD OF THE INVENTION

The invention relates to a method according to the preamble of claim 1 for producing a cage of a rolling bearing that receives rolling bodies, a cage produced by this method as claimed in claim 6 and a cage as claimed in claim 7.

It is known from practice to produce cages for receiving rolling bodies from plastics material, for example from a thermoplastic material, by the injection-molding process. Plastic cages of this type allow the body of the cage to be fitted with the rolling bodies as a final method step. When doing so, it is found to be difficult that cages with a body made of a thermoplastic material have only low mechanical strength at high temperatures. The choice of specifically high-temperature resistant thermoplastics as the material for the body of the cage increases the production costs thereof significantly. The addition of filling materials reduces the rupture strength of the cages, in particular when they contain a high proportion of filling material.

EP 0 644 344 B1 describes a method for producing a cage of a rolling bearing that receives rolling bodies, the body of the cage being produced from a plastics material that can be crosslinked when exposed to radiation, in particular when exposed to beta radiation, and the body of the cage being fitted with rolling bodies during the further course of the method. When carrying out the method, it is provided that the produced body of the cage is first fitted with the rolling bodies and then exposed to the radiation. It proves to be disadvantageous here that the rolling bodies received in the body partially shield the adjacent region of the body from the radiation, so that, specifically in the vicinity of the rolling bodies, the strengthening of the body is incomplete. It is also unfavorable that the cage already fitted with the rolling bodies has a great weight and is awkward to handle for the subsequent irradiation. It has also been found that a major advantage of plastic cages, that is being able to carry out the fitting of the cage with the rolling bodies right at the end of the method for producing the cage, is lost.

### OBJECT OF THE INVENTION

The object of the invention is to make it easier for the method mentioned at the beginning for producing a cage to be carried out.

### SUMMARY OF THE INVENTION

This object is achieved according to the invention by a method as claimed in claim 1, a preferred way of carrying out the method using a cage as claimed in claim 7 and allowing said cage to be produced.

The invention is based on the realization that crosslinking at room temperature leads only to little stiffening of the body of the cage, so it is also quite possible for a previously crosslinked body of the cage to be fitted with the rolling bodies. Only at higher temperatures does the crosslinking show its effect in an increased modulus of elasticity compared with non-crosslinked cages. The prior crosslinking of the plastics material of the body of the cage consequently does not hinder the fitting of the cage with rolling bodies.

It consequently proves to be an advantage for the production of the cage that the crosslinking can be carried out directly after the production of the body of the cage, for example by injection molding of the plastics material, while the fitting of the body with the rolling bodies can be carried out at a separate time from the crosslinking, possibly also at a separate location. Crosslinked cages can be kept in stock as intermediate products that can be fitted with the rolling bodies as and when required.

For carrying out the method, it is preferably provided that a thermal treatment of the body of the cage is carried out before the fitting of the cage with the rolling bodies. This thermal treatment serves in addition to the crosslinking by radiation for the mechanical strengthening of the body of the cage. This thermal treatment may be carried out by radiant heaters, which either irradiate the body of the cage as a whole or only individual portions of the body, for example those portions of the body that do not receive the rolling bodies directly.

For carrying out the step of the additional thermal treatment, it is preferably provided that the thermal treatment is carried out after the radiation exposure, so that the cage stiffened only a little by the crosslinking radiation at room temperature is strengthened by the thermal treatment to the extent that the subsequent fitting of the cage with the rolling bodies is made easier.

With regard to the radiation bringing about the crosslinking of the plastics material, it is preferably provided that the radiation is high-energy electromagnetic radiation, in particular x-radiation. X-radiation can be easily applied over a surface area, in particular in comparison with alpha or beta radiation; specifically, the cages produced from the crosslinkable plastics material can leave the plastics molding device, specifically the injection-molding device, on a conveyor belt and be taken to a chamber in which the cages are exposed to the x-radiation, so that the crosslinking of the plastics material of the cages can be carried out directly after the production of the cages.

With regard to the production of the body of the cage from a material that can be crosslinked when exposed to radiation, it is preferably provided that the produced body of the cage comprises pigments which change color when exposed to the radiation. The pigments added to the material of the body change the mechanical properties of the body only in a negligible way, but the change of color of the pigments makes it possible to detect whether the body has been exposed to the radiation or whether the radiation has irradiated the body uniformly. In particular, the pigments make it possible to detect whether the crosslinking of the material of the cage has been carried out completely, and consequently whether the method step has been completed.

It goes without saying that pigments may be provided in the material of the body of the cage irrespective of whether the fitting of the cage with rolling bodies is carried out before or after the irradiation of the body. It also goes without saying that pigments may likewise indicate whether the body of the cage has undergone a thermal treatment. If need be, two types of pigments may be provided, the first type changing color when it is irradiated with high-energy radiation, specifically with x-radiation, and the second type of pigments changing color when it undergoes a thermal treatment.

The choice of pigments, the arrangement of the pigments on the surface or in the depth of the body of the cage and the conditions under which the pigments experience the change of color also make it possible to allow the cage to be provided with a coding, represented by the pigments, in such a way that a specific cage or specific batch of cages can be easily identified and forgeries verified, since, although a forger can simply imitate a color of the cage, the choice of pigments and their arrangement before the change of color can be kept secret and, if need be, changed easily and at short notice, without the color of the cage after the change of color of the pigments changing significantly.

Further advantages and features of the invention emerge from the dependent claims and from the following description of an exemplary embodiment.

The invention is described and explained in more detail below with reference to the accompanying drawings.

### BRIEF DESCRIPTION OF THE DRAWINGS

FIG. 1 shows stress-strain curves for a radiation-crosslinkable plastics material, recorded at room temperature (left part of the image) and at higher temperatures (right part of the image), and

FIG. 2 schematically shows a flow diagram of how, by way of example, the method according to the invention is carried out when producing an exemplary embodiment of a cage according to the invention.

### DETAILED DESCRIPTION OF THE DRAWINGS

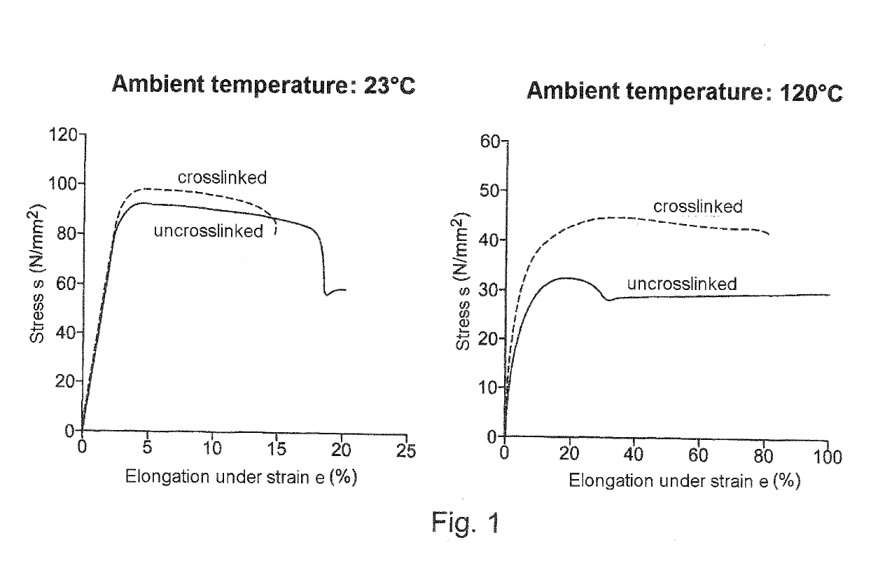

FIG. 1 shows in two partial diagrams two stress-strain curves which were recorded in a tensile test in accordance with DIN EN ISO 53455 on a radiation-crosslinkable plastics material (PA66, polyamide 66), to be precise before and after the crosslinking of the plastics material under x-ray exposure. It can be seen that, at room temperature (23° C., left part of the image), the crosslinking does not bring about any significant increase in the strength of the plastics material, while the crosslinking of the plastics material at an ambient temperature of 120° C. (right part of the image), as may occur under operating conditions of a rolling bearing, leads to a detectable increase in the strength or stiffness of the plastics material. A plastic cage of PA66 crosslinked at room temperature can consequently be fitted with rolling bodies similarly easily as a non-crosslinked cage. It is likewise within the scope of the concept of the invention if the radiation-crosslinked cage has reduced elongation at rupture in comparison with the non-crosslinked cage at room temperature.

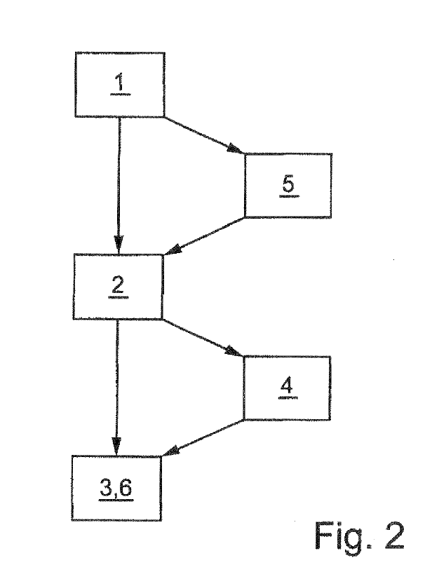

FIG. 2 shows how by way of example the method according to the invention is carried out. In a first method step 1, the body of the cage is produced; the body consists of a radiation-crosslinkable thermoplastic material, for example PA66, or of a thermosetting material. The body has been obtained by a plastics-molding process, in particular as an injection molding.

In a second method step 2, the body is exposed to high-energy radiation, particularly preferably x-radiation. This radiation leads to a crosslinking of the plastics material that brings about a strengthening of the body of the cage that is only little at room temperature but noticeable at higher temperatures.

In a third method step 3, the body of the cage is fitted with rolling bearings. For this purpose, the body produced at the beginning has receptacles for the rolling bodies.

In a preferred way of carrying out the method, a thermal treatment 4, 5 or 6 may be provided. The thermal treatment of the body may be carried out as a further method step 4 after the radiation crosslinking of the material of the body, in addition or as an alternative to it after the body of the cage is produced and before the irradiation is carried out, as a further method step 5, or in turn in addition or as an alternative to the two aforementioned possibilities, as a further method step 6, during the fitting of the body of the cage with the rolling bodies.

The invention has been described above on the basis of an exemplary way of carrying it out in which a body was produced from PA66. It goes without saying that other radiation-crosslinkable plastics materials may also be provided. In particular, different types of polyamide, types of polyetherether ketone, polypropylene, polyethylene or polyurethane may also be provided as the plastics material. Furthermore, it may be provided that the radiation-crosslinkable plastics material contains plasticizers or crosslinking promoters as admixtures. Furthermore, it may also be provided that the plastics material may contain further additions such as reinforcing fibers.

In the exemplary way of carrying out the invention described above, the body of the cage as a whole was formed from the radiation-crosslinkable plastics material. The invention likewise relates to those cages which only consist of a radiation-crosslinkable plastics material in certain portions, for example in the region of the receptacles for the rolling bodies, but are formed from a different material in other regions.

The thermal treatment 4, 5 or 6 described for the exemplary way of carrying out the invention described above may be carried out on the body of the cage as a whole or else only on certain portions, for example in the region of the receptacles for the rolling bodies.

As a departure from or in addition to the exemplary way of carrying out the invention that has been described, the radiation under the exposure to which the crosslinking of the material of the body of the cage is brought about may also be gamma radiation, ultraviolet radiation or high-energy radiation in the range of visible light. Furthermore, it may be provided that high-energy particle rays such as alpha or beta rays also bring about the crosslinking of the material of the cage.

The invention is likewise not restricted to those methods at the beginning of which the body is produced as an injection molding. The body may also be produced by other processes for molding plastics and provided for the method described above.

### LIST OF DESIGNATIONS

1 First method step
2 Second method step
3 Third method step
4 Thermal treatment
5 Thermal treatment
6 Thermal treatment

1-7. (canceled)

8. A method for producing a cage, which has a body, of a rolling bearing that receives rolling bodies, the method comprising the following steps:
producing the body of the cage from a cross-linkable thermoplastic plastic material;
exposing the body to radiation; and
fitting the body of the cage with the rolling bodies after the body is exposed to radiation.

9. The method as claimed in claim 8, further comprising a thermal treatment of the body of the cage before the fitting of the cage with the rolling bodies.

10. The method as claimed in claim 9, the thermal treatment is carried out after the cage us exposed to the radiation.

11. The method as claimed in claim 8, wherein the radiation is high-energy electromagnetic radiation.

12. The method as claimed in claim 11, wherein the high-energy electromagnetic radiation is x-radiation.

13. The method as claimed in claim 8, wherein the radiation is particle radiation.

14. The method as claimed in claim 8, wherein the producing step includes producing the body of the cage to include pigments which change color when exposed to the radiation.

15. A cage of a rolling bearing which receives rolling bodies, comprising:
a body which is produced from a plastic material that can be cross-linked by exposure to radiation and which is fitted with the rolling bodies.

16. A cage for receiving rolling bodies of a rolling bearing, comprising:
a body made of a plastic material containing pigments which change color under an influence of radiation and/or heat.
